(19) United States
(12) Patent Application Publication
(10) Pub. No.: US 2009/0271248 A1
(43) Pub. Date: Oct. 29, 2009

(54) PRECALCULATION OF TRENDING ATTRIBUTES

(75) Inventors: Renae A. Sherman, Lake Forest, CA (US); Angela R. Granger, Irvine, CA (US)

Correspondence Address: KNOBBE MARTENS OLSON & BEAR LLP, 2040 MAIN STREET, FOURTEENTH FLOOR, IRVINE, CA, 92614, US

(73) Assignee: EXPERIAN INFORMATION SOLUTIONS, INC., Costa Mesa, CA (US)

(21) Appl. No.: 12/413,278

(22) Filed: Mar. 27, 2009

Related U.S. Application Data
(60) Provisional application No. 61/040,083, filed on Mar. 27, 2008.

(51) Int. Cl. G06Q 10/00; G06Q 40/00

(52) U.S. Cl. 705/10

(57) ABSTRACT

A credit attribute delivery system receives consumer financial data and generates trending attributes. The trending attributes are stored in a precalculated trending attribute database. The credit attribute delivery system may respond to a request for consumer trending attributes in a real time manner by accessing and providing the trending attributes stored in the precalculated trending attribute database.

### CROSS-REFERENCE TO RELATED APPLICATIONS

This application is based upon and claims the benefit of priority from U.S. Provisional Patent Application No. 61/040,083 filed on Mar. 27, 2008, the entire contents of which are incorporated herein by reference. All publications and patent applications mentioned in this specification are herein incorporated by reference to the same extent as if each individual publication or patent application was specifically and individually indicated to be incorporated by reference.

### BACKGROUND OF THE INVENTION

1. Field of the Invention

The invention relates to systems and methods for providing credit behaviors to requesting entities on a substantially realtime basis.

2. Description of the Related Art

Past consumer behavior may be used to classify consumers into groups or to predict future consumer behavior. Predictions of consumer behavior and consumer classifications may be used to increase the effectiveness of marketing for consumer services that are provided by financial service providers, and help financial service providers attract and retain customers. Predictions of consumer behavior and consumer classifications may also identify high-risk accounts.

### SUMMARY OF THE INVENTION

In one embodiment, a computer readable medium stores software code configured for execution by a computing device having one or more processors, wherein the software code is configured to cause the computing device to identify and transmit precalculated trending attributes indicative of past credit-related behaviors of consumers to a requesting business entity in a substantially real-time manner. In one embodiment, the method comprises receiving a request for trending attributes associated with a plurality of consumers, wherein the request includes at least a name and address for each of one or more consumers for which behavior indications are requested, identifying precalculated trending attributes associated with respective of the plurality of consumers as stored in at least one precalculated trending attributes data store, and transmitting at least some of the identified trending attributes to a requesting entity, wherein the process of identifying and transmitting is performed substantially real-time.

In one embodiment, a computerized method of providing indications of consumer behaviors with respect to financial accounts associated with the consumers, the method configured for execution on a computing system comprising one or more computing devices, comprises determining one or more attributes associated with each of a plurality of respective consumers based on trending models that are applied to financial data associated with respective consumers, storing on a physical storage device indications of the determined attributes for each of the respective consumers, receiving a request for attributes associated with only a subset of the plurality of consumers, wherein the request includes at least a name and address for each of one or more consumers for which behavior indications are requested, and transmitting at least some of the attributes associated with respective of the subset of consumers, wherein the process of receiving and transmitting is performed substantially real-time.

In one embodiment, a computing system is configured to determine credit trending attributes for transmission to a client device, wherein the credit trending attributes are each indicative of at least one credit-related transaction of respective consumers and the credit trending attributes are predictive of future credit behavior of each of the plurality of respective consumers. In one embodiment, the computing system comprises a processor configured to execute one or more modules, an interface to a network of computing devices, a trending module configured for execution by the processor in order to generate one or more trending attributes for each of a plurality of consumers by applying one or more respective trending models to credit data corresponding to respective consumers, a precalculated trending attribute data structure configured to store the one or more trending attributes associated with respective consumers, the precalculated trending attribute data structure comprising an interface module configured to intermittently receive requests for trending attributes from various business entities and, in response to those requests identify one or more stored trending attributes in the precalculated trending attribute data structure associated with each respective consumer identified by a requesting business entity and transmit indications of the stored trending attributes to the requesting business entity, wherein the identifying and transmitting is performed substantially realtime.

A computerized method of providing indications of consumer behaviors with respect to credit accounts associated with the consumers to requesting business entities, the method configured for execution on a computing system comprising one or more computing devices comprises determining by the computing system one or more attributes associated with each of a plurality of respective consumers based on credit data associated with respective consumers and one or more trending models that are applied to credit data associated with respective consumers, wherein each attribute is indicative of one or more credit-related transaction of the respective consumers, storing on a physical storage device indications of the determined attributes for each of the respective consumers, receiving from a business entity computing device a request for respective behavior indications associated with only a subset of the plurality of consumers, wherein the request includes at least a name and address for each of one or more consumers for which behavior indications are requested, determining by the computing system at least one behavior indication for each of the subset of consumers based on at least some of the determined attributes associated with the respective consumers, wherein the behavior indication indicates whether respective consumers are more likely to use credit as one or more of a rate surfer, a revolver, or a transactor, and transmitting to the requesting business entity computing device at least some of the attributes and the determined behavior indications for respective of the subset of consumers, wherein the process of receiving, determining, and transmitting is performed substantially real-time.

### BRIEF DESCRIPTION OF THE DRAWINGS

FIG. 1 is a block diagram illustrating one embodiment of a credit attribute delivery system.

FIG. 2 is a flow diagram illustrating one embodiment of the present invention, as well as the temporal flow of data between the devices

FIG. 3 is a flowchart illustrating one embodiment of a method of precalculating trending attributes.

FIG. 4 is a flowchart illustrating one embodiment of a method of receiving precalculated trending attributes.

FIG. 5 is a block diagram illustrating one embodiment of a credit database.

FIG. 6 is a diagram illustrating one embodiment of a customer data record containing trending attributes that may be store in a precalculated trending database and accessed by one or more clients.

FIG. 7 is a flow diagram illustrating a credit attribute delivery system receiving information from a client via a user interface, retrieving pre-calculated trending attributes for the consumer indicated in the information, and providing a resulting user interface including trending attribute information to the client.

### DETAILED DESCRIPTION OF CERTAIN EMBODIMENT

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

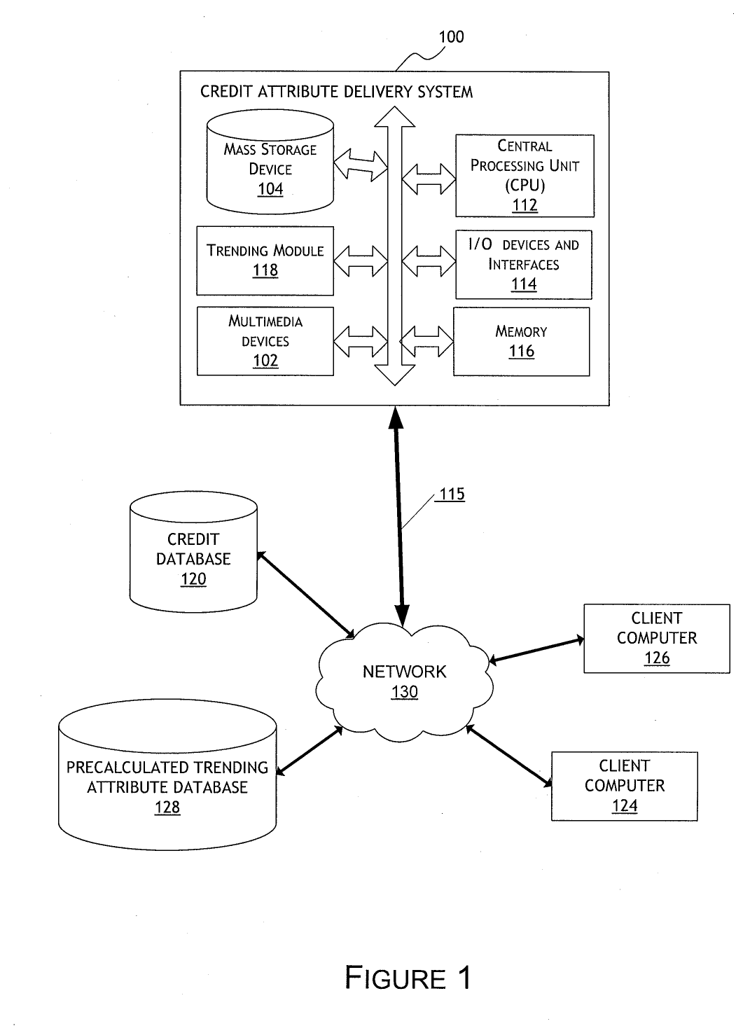

FIG. 1 is a block diagram illustrating one embodiment of a trending attribute delivery system 100, also referred to herein as the system 100. In the embodiment of FIG. 1, the system 100 is in communication with a network 130 and various external entities that are also in communication with the network 130. The system 100 may be used to implement certain systems and methods described herein. For example, in one embodiment the system 100 may be configured to apply trending models (also referred to as “models” or “trending algorithms”), for example trending models associated with credit-related trends of consumers, in order to generate trending data (also referred to herein as “trending attributes”) for each of a plurality of consumers. Trending attributes may be used to evaluate trends in customers' credit behavior on all their credit cards and/or loans over a period of time in order to allow lenders and/or other interested parties to establish effective credit campaigns directly aligned to their customer portfolio strategy. For example, credit data and/or other financial data associated with consumers spanning various periods, such as 1 week, 2 weeks, 4, weeks, 1 month, 2 months, 3 months, 4 months, 6 months, 9 months, 12, months, 18 months, 24 months, or any other times period, may be accessed by certain trending models. Financial data, such as balance history, may be examined within particular accounts of interest, as well as across multiple accounts, such as multiple accounts of a certain type.

Trending attributes may be predictors of individual or group consumer credit behavior. For example, trending models may be used to generate trending attributes that are used to segment consumers into one or more of the following behavior segments:
Revolver: carry one or more credit balances from month to month
Transactor: pay off credit balances each month
Rate surfer: frequently transfer credit balances (e.g., probably to get lower interest rates and may not ever fully utilize the account)
Consolidator: transfer balances from two or more accounts into one account
Non-activator: get an account but never use it or use it for a short time only

In addition, trending attributes may provide seasonality information on who has a balance peak or valley on the account at the same time each year, for example. Trending attributes may include

In one embodiment, trending attributes may segment consumers into one or more personality types, such as one or more of:
Credit Rookie—newest to the credit card or loan market, Credit Rookies may have only one credit account with the company so are nurtured to gain their loyalty. They are usually young, but mature consumers can also enter this segment
Simple Lifers—the loyal bedrock for the card or loan issuer they choose, this segment likes to keep things easy. They rarely switch, have a very controlled approach to spending, and reject temptation to adopt more disloyal behavior.
Practical Shoppers—multiple active cards or loans, but used practically. This segment also likes to make the most of store cards, so that they get the best offers. They often have a number of inactive cards, so companies like to nurture them
Rate Surfers—a well-known phenomenon where the consumer takes the best offer of credit or loan and then switches as soon as a better offer is available. No sign of financial stress, but lenders frequently need to deal better with this group as they can be costly
Credit Maximisers—more than one card but with no major financial stress, these consumers like to spend, sometimes stretching beyond their means
Plate Spinners—heavy users of credit cards and loans, often switching balances between accounts rather than using offers to pay down their overall debt. They are a hidden risk phenomenon in today's society with the easy availability of credit
Credit Strangers—this group shows behavior patterns that fall into no specific segment, either because the issuer has lost touch with the individual or their information cannot be processed

In one embodiment, a set of trending attributes may be generated from each trending algorithm. These trending attributes may be used, for example, as a marketing solution add-on for a credit issuer's prescreen and account monitoring programs. When paired with prescreen programs, these trending attributes may provide additional information to increase the profitability potential of mail campaigns by allowing offerings to be tailored to consumer credit usage patterns. As an adjunct to an account monitoring program, the trending attributes may help determine the appropriate cross-sell opportunities and incentives for each consumer/account, thereby deepening customer relationships while increasing retention rates and profit potential.

In one embodiment, the system 100 generates trending attributes for each of a plurality of consumers for which credit data is available in a credit database, and the trending attributes are advantageously pre-calculated, e.g., calculated prior to being requested by various types of clients, e.g. a financial institution, so that the pre-calculated trending attributes are readily available when requested by a client. The functionality provided for in the components and modules of system 100 may be combined into fewer components and modules or further separated into additional components and modules.

The system 100 may be a server or a personal computer, for example an IBM, a Macintosh, or a Linux/Unix compatible computer. In one embodiment, the computing device may be a laptop computer, a cell phone, a personal digital assistant, a kiosk, or an audio player, for example. In one example embodiment, the system 100 includes one or more central processing units (“CPU”) 112, which may include a conventional microprocessor. The system 100 further includes a memory 116, such as random access memory (“RAM”) for temporary storage of information and a read only memory (“ROM”) for permanent storage of information, and a mass storage device 104, such as a hard drive, diskette, or optical media storage device. Typically, the modules of the system 100 are connected using a standards based bus system. In different embodiments, the standards based bus system could be Peripheral Component Interconnect (PCI), Microchannel, SCSI, Industrial Standard Architecture (ISA) and Extended ISA (EISA) architectures, for example.

The system 100 may be generally controlled and coordinated by operating system software, such as Windows 95, Windows 98, Windows NT, Windows 2000, Windows XP, Windows Vista, Windows 7, Linux, SunOS, Solaris, Palm OS, Blackberry OS, or other compatible operating systems. In Macintosh systems, the operating system may be any available operating system, such as MAC OS X. In other embodiments, the system 100 may be controlled by a proprietary operating system. Conventional operating systems control and schedule computer processes for execution, perform memory management, provide file system, networking, and I/O services, and provide a user interface, such as a graphical user interface (“GUI”), among other things.

The exemplary system 100 includes one or more commonly available input/output (I/O) devices and interfaces 114, such as a keyboard, mouse, touchpad, and printer. In one embodiment, the I/O interfaces and devices 114 comprise devices that are in communication with modules of the system 100 via a network, such as the network 130 and/or any secured local area network. In another embodiment, the I/O devices and interfaces 114 include one or more display devices, such as a monitor, that allows the visual presentation of data to a user. More particularly, a display device provides for the presentation of GUIs, application software data, and multimedia presentations, for example. The system 100 may also include one or more multimedia devices 102, such as speakers, video cards, graphics accelerators, and microphones, for example.

In the embodiment of FIG. 1, the I/O devices and interfaces 114 provide a communication interface to various external devices. In the embodiment of FIG. 1, the system 100 is coupled to a network 130, such as any combination of one or more networks, including LANs, WANs, and/or the Internet, for example, via a wired, wireless, or combination of wired and wireless, communication link 115. Various computing devices and/or other electronic devices communicate via the network 130. In the exemplary embodiment of FIG. 1, a credit database 120, trending attribute database 128, client computer 124, and client computer 126 are each coupled to the network 130.

In the embodiment of FIG. 1, the system 100 also includes a trending module 118. The trending module 118 may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In the embodiments described herein, the system 100 is configured to execute the trending module 118, among others, in order to generate trending attributes, create profiles, and/or to provide assessment information regarding certain consumers, including individuals, entities, and or groups of consumers. For example, in one embodiment the trending module 118 is configured to generate trending attributes indicating an individual consumer's propensity to be a revolver type and express as a percentage (or other figure) the individual consumer's attributes of a revolver type model. As another example, in one embodiment the trending module 118 is configured to generate trending attributes indicating an individual consumer's propensity to perform certain credit related activities. As noted above, although the description provided herein refers to consumers, the term consumer should be interpreted to include groups of consumers, such as, for example, married couples or domestic partners, and business entities.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

In one embodiment the precalculated trending attribute database 128 (also referred to herein as “trending attribute database 128”) includes one or more computing devices and/or storage devices. In some embodiments, the precalculated trending attribute database 128 may include a relational database, such as Sybase, Oracle, CodeBase and Microsoft® SQL Server as well as other types of databases such as, for example, a flat file database, an entity-relationship database, an object-oriented database, and/or a record-based database. The precalculated trending attribute database 128 may receive and store trending attributes received from the system 100, such as trending attributes generated by the system 100. The precalculated trending attribute database 128 may also transmit trending attributes to the system 100, the client computers 124, 126, such as in response to received requests for trending attributes. The precalculated trending attribute database 128 may be configured to respond to a request for precalculated trending attributes from a client computer 124, 126, for example, in a substantially real-time manner. In other embodiments, the system 100 may include the precalculated trending attribute database 128 and/or a copy of all or a portion of the precalculated trending attributes.

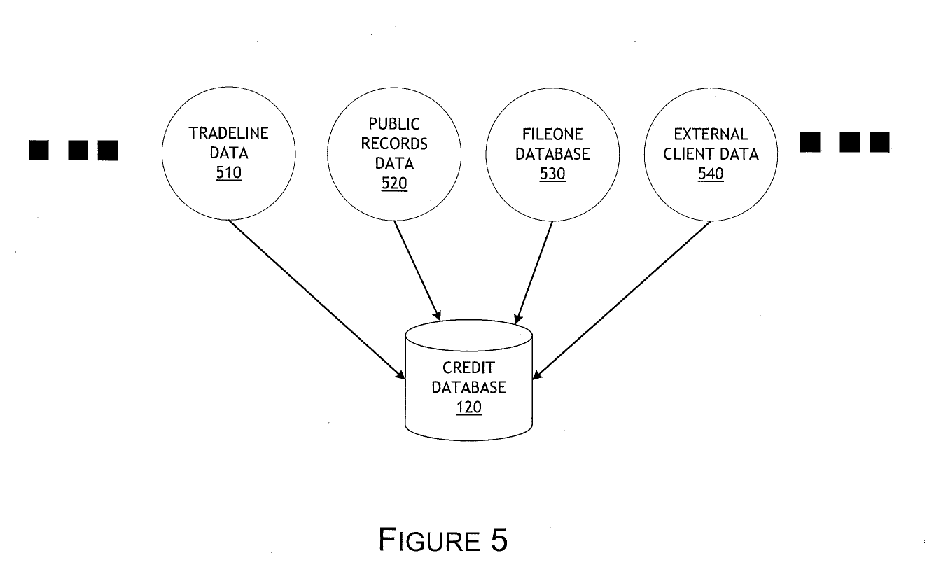

In one embodiment, the credit database 120 includes one or more computing devices and/or storage devices. The credit database 120 may store credit data from various sources. For example, the credit database 120 may include credit data from a credit bureau, such as Experian, TransUnion, Equifax, any agency thereof, or any other credit bureau. The credit database 120 may provide the data stored thereon to the system 100, such as in response to a request from the system 100. The credit database 120 is described in more details below in the discussion of FIG. 5.

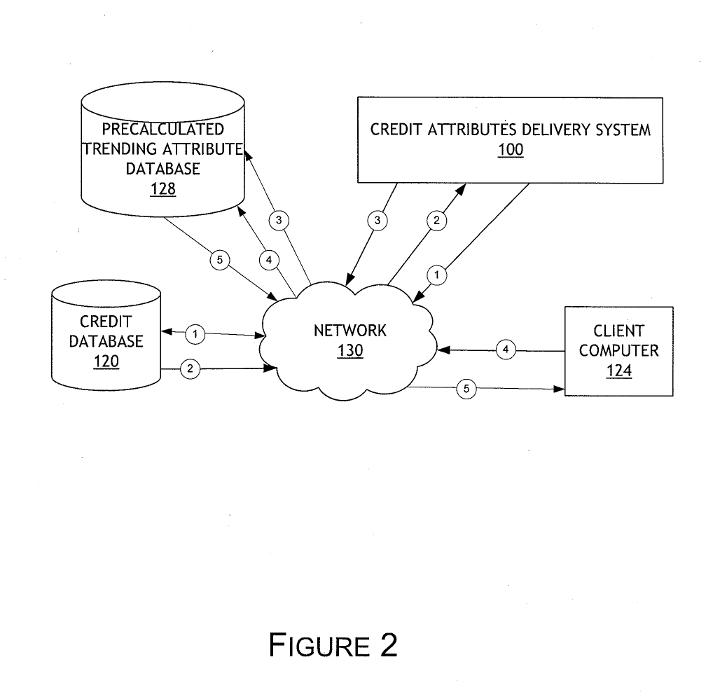

FIG. 2 is a data flow diagram illustrating one embodiment of certain devices of FIG. 1 in operation, including the temporal flow of data between the devices. In stage 1, the system 100 accesses credit data for some or all consumers stored in the credit database 120. Depending on the embodiment, the data in the credit database is updated continually and/or periodically with credit data associated with consumers. In one embodiment, the credit database 120 comprises only credit data associated with certain trade types, such as bankcard, retail, unsecured line of credit, second mortgage, and/or HELOC related credit data. In stage 2, the system 100 accesses the credit data from the credit database 120 and applies trending algorithms to the credit data of respective consumers in order to generate one or more trending attributes for some or all consumers. In stage 3, the system 100 stores the trending attributes for some or all consumers in the precalculated trending attribute database 128, such that the precalculated trending attributes are readily available for use. In stage 4, a client computer 124 provides a request for trending attributes that may include a listing of consumers for which trending attributes are desired and that may specify the requested portions of the trending attributes for the respective consumers. For example, the consumer list may include information identifying consumers that are applying for a line of credit with the client. The consumer list is forwarded to the trending attribute database 128 (e.g., via a web interface, FTP file transfer, or other electronic transfer) and, in stage 5, the requested portions of the precalculated trending attributes are transmitted to the client computer 124 from the trending attribute database 128 in a substantially real-time transaction. As used herein, the term real-time generally describes a transaction that occurs during a single online session, such as while a user of the client computer 124 is logged onto a server of the precalculated trending attribute database 128. In one embodiment, real-time transactions occur in the time necessary for a webpage to load, such as the time between when a list of customers on which trending attributes are requested is submitted via a webpage until a responsive webpage, e.g., displaying the requested trending attributes, is provided to the client computer. In one embodiment, real-time transactions may occur as quickly as 1-3 seconds, or shorter time, or may require additional time, such as 5-60 seconds. In other embodiments, real-times transactions may require a few minutes to complete, such as 1-5 minutes or more.

In one embodiment, a client request for trending attributes for one or more consumers is transmitted directly to the system 100, which generates a unique identifier for each of the consumers on the client list and the unique identifiers are used by the system 100 to request precalculated trending attributes from the database 128 on behalf of the client computer 124. In this embodiment, the trending attributes may be either returned directly to the client computer 124 from the precalculated trending attributes database 128 or may be transmitted to the system 100 which then transmits the trending attributes to the client computer 124, possibly with additional formatting and/or information attached to the trending attributes, such as one or more behavior segments associated with certain or all of the returned trending attributes.

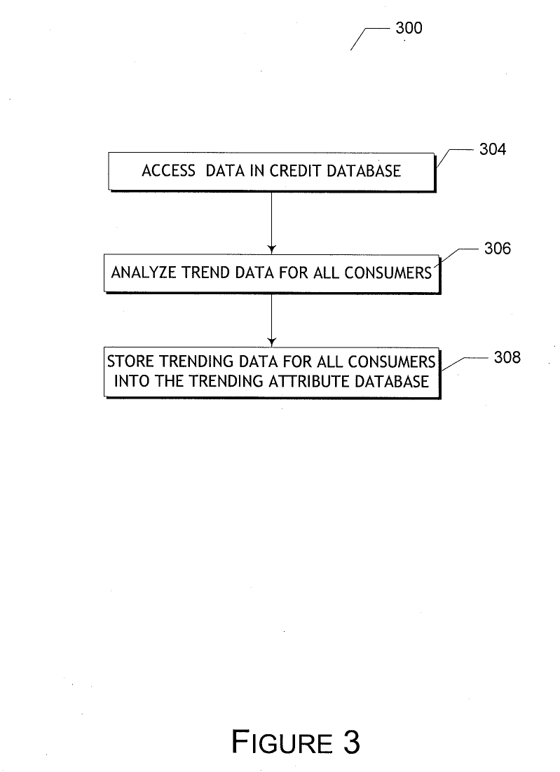

FIG. 3 is a flowchart illustrating one embodiment of a method of generating a plurality of trending attributes for storage in the trending attribute database 128. The method of FIG. 3 may be repeated periodically (e.g. nightly, weekly, and/or monthly) to update or regenerate the precalculated trending attributes stored in the trending attribute database 128 so that the trending data reflects the most recent data of consumer credit behavior. In one embodiment, copies of historical trending attributes are maintained, such as on the database 128, such that changes in the trending attributes over time may be monitored. Depending on the embodiment, the method of FIG. 3 may include fewer or additional blocks and the blocks may be performed in a different order than is illustrated.

Beginning in block 304, the system 100 accesses credit data in the credit database 120, such as credit data associated with a predetermined subset of trade types for a plurality of consumers. The credit data in the credit database 120 may be received from one or more of various data sources, such as those described in FIG. 5 below.

In block 306, the system 100 applies trending algorithms to the credit data of respective consumers in order to determine one or more trending attributes for each of the consumers having credit data stored in the credit database 120. In one embodiment, the system 100 accesses credit data stored in the credit database 120 and, using the trending module 118, generates trending attributes for all customers stored in the credit database 120. In another embodiment, the system 100 is provided access to the credit data stored in the credit database 120, and using a trending module 118 physically located on the same system wherein the credit database 120 is currently executing (not shown), is able to applying trending algorithms in order to generate trending attributes for all consumers for whom credit data is stored in the credit database.

In block 308, the system 100 or the credit database 120 stores the generated trending attributes for all consumers in the precalculated trending attribute database 128. In one embodiment, the system 100 utilizes a network connection to transfer trending attributes from the mass storage device 104 of the system 100 to the trending attribute database 128. After the trending attributes have been stored in the trending attribute database 128, the trending attributes can be accessed by external client computers, for example, by client computer 124 or client computer 126 to fulfill client requests for consumer trending attributes in a substantially real-time manner.

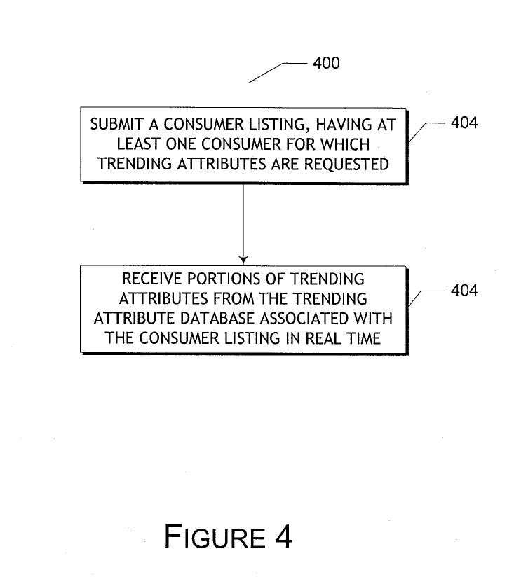

FIG. 4 is a flowchart illustrating one embodiment of a method of providing precalculated trending attributes related to at least one consumer, e.g., identified in a client listing supplied by the client, to the client. The method of FIG. 4 may be performed periodically to retrieve trending attributes for at least one consumer listed by the client computer 124 or 126. Depending on the embodiment, the method of FIG. 4 may include fewer or additional blocks and the blocks may be performed in a different order than is illustrated.

In block 404, the client computer 124 or 126 of FIG. 1 transmits a consumer listing, including information regarding at least one consumer for which trending attributes are requested. In one embodiment, the client computer 124 or 126 may submit a listing using a batch process wherein the listing is a compilation of consumer data for a plurality of consumers. For example, a file (e.g., a comma separated values (CSV), eXtendible markup language (XML), any spreadsheet or database file formats, and/or a proprietary format) may be transmitted to the precalculated trending attributed database 128 and/or system 100. In another embodiment, the client computer 124 or 126 may submit a listing wherein only one or a few consumers are listed for which precalculated trending attributes are requested. For example, a lender may perform the method of FIG. 4 each time a borrower applies for a loan or line of credit. In one embodiment, the lender (or other client) may be provided with a browser-accessible (or other Internet-accessible) user interface that accepts data regarding the customer. For example, the lender may enter a name, addresses, and possible other information regarding the consumer into the provided user interface, submit the information to the system 100 via a web form, and receive in a returned web form (see block 404 below) the corresponding trending attributes for the consumer. In some embodiments the listing includes a unique consumer identifier for one or more consumers.

In block 404, the client computer 124 or 126 receives the requested precalculated trending attributes associated with the one or more consumers indicated in their consumer listing. In one embodiment, the client computer 124 receives the trending attributes from the trending attribute database 128 in real-time. In another embodiment, the client computer 124 receives the trending attributes from the system 100 in real-time. In other embodiments, the client computer 124 may not receive the trending attributes from the trending attribute database 128 and/or the system 100 in real time. In other embodiments, the trending attributes may be delivered according to a selected schedule, for example nightly or every seven days.

FIG. 5 is a diagram illustrating an exemplary embodiment of the credit database 120. The credit database 120 stores credit data obtained from various data sources, including but not limited to tradeline data 510, public records data 520, the credit bureau database 530, and external client data 540. In addition, the credit data may include externally stored and/or internally stored data. In certain embodiments, tradeline data 510 and public records data 520 are also stored by the credit bureau database 530. In other embodiments, the credit database 120 comprises only a subset of the data available from the various data sources set forth above.

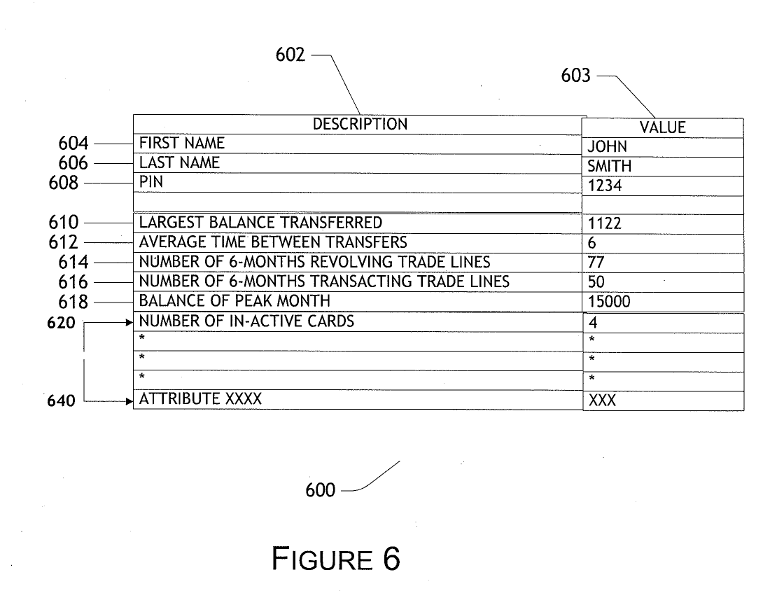

FIG. 6 is diagram illustrating an exemplary embodiment of a consumer data record 600 containing trending attributes that may be stored in the precalculated trending attribute database 128 and accessed by clients. In the embodiment of FIG. 6, each of the trending attributes comprises a description in column 602 and a trending value in column 603. As illustrated in FIG. 6, the exemplary consumer data record 600 comprises a first name 604, a last name 606, and at least one personal identification number (PIN) 608 associated with at least one consumer. The exemplary trending attributes of FIG. 6 comprise: “Largest Transferred Balance” having an attribute value of “1122;” “Average Time Between Transfers” having an attribute value of “6;” “Number of 6-Months Revolving Trade Lines” having an attribute value of “77;” “Number of 6-Months Transaction Trade Lines” having an attribute value of “50;” “Balance of Peak Month” having an attribute value of “15000;” and “Number of In-Active Cards” having an attribute value of “4.” Moreover, the consumer data record 600 may further comprise a plurality of other trending attributes, as in rows between row 620 and row 640; where row 640 is used to show a generic attribute description of “Attribute XXX” and a respective generic attribute value of “XXX.”

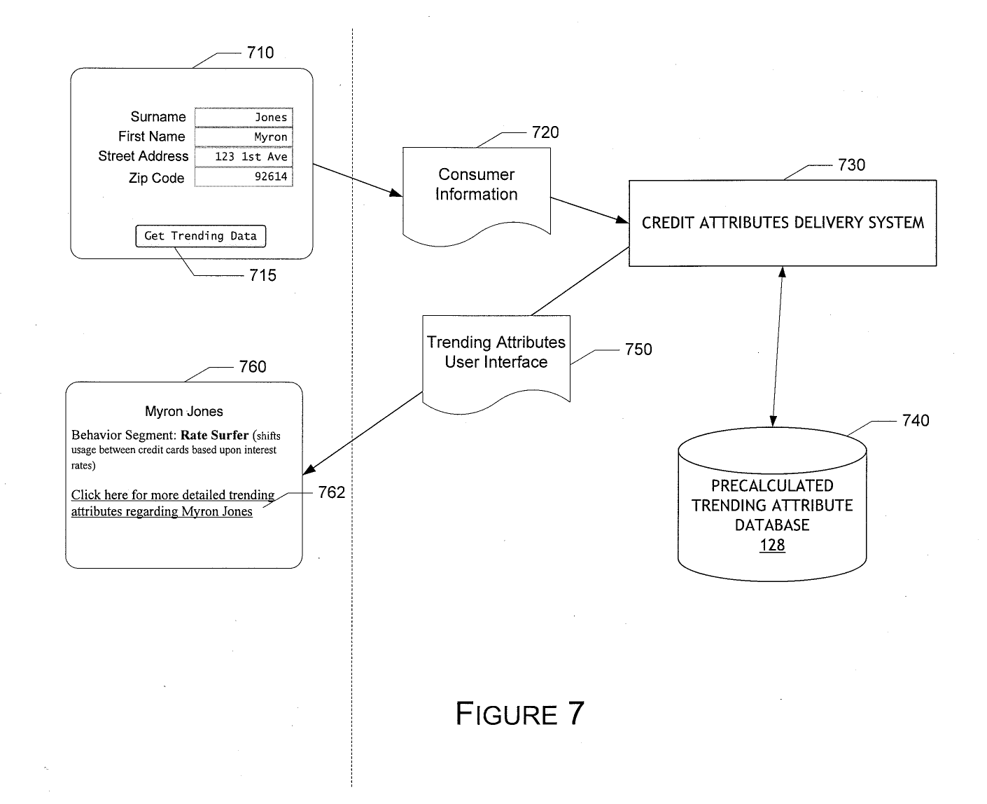

FIG. 7 is a flow diagram illustrating a credit attribute delivery system 730 receiving information from a client via a user interface 710, retrieving pre-calculated trending attributes for the consumer indicated in the information, and providing a result user interface 760 including trending attribute information to the client. Depending on the embodiment, the user interfaces 710, 760 of FIG. 7 may be viewed in an internet browser or a stand-alone software. Depending on the embodiment, the embodiment of FIG. 7 may include fewer or additional devices than is illustrated in FIG. 7.

In the client interface 710, a client enters consumer information identifying a consumer for whom trending attributes are desired. In the illustrative embodiment shown, the consumer's surname (“Jones”), first name (“Myron”), street address (“123 1^{st} Ave”), and zip code (“92614”) are entered. When the client selects the Get Trending Data button 715, the interface transmits the consumer information 720 that was entered on the client interface to the credit attributes delivery system 100. In other embodiments, the consumer information 720 may be transmitted to other devices, e.g., the precalculated trending attribute database 128.

In this illustrative embodiment, after the credit attributes delivery system 730 receives the consumer information, the credit attributes delivery system 730 sends a request to the precalculated trending attribute database 128 for trending attributes for the consumer (or consumer in other embodiments) indicated in the consumer information 720, e.g., Myron Jones. The trending attributes for Myron Jones are located in the precalculated trending attribute database 128 and transmitted to the credit attributes delivery system 100. In one embodiment, the system 730 determines a behavior segment (e.g., rate surfer, transactor, consolidator, etc.) based on the trending attributes of the consumer. In one embodiment, the client request only attributes associated with one or more behavior segments and/or certain attributes.

The credit attributes delivery system 730 then generates and transmits the trending attributes user interface 750, such as an CSV, HTML, XML, or other web accessible page, to the client device where the user interface 760 is immediately displayed. In the embodiment of FIG. 7, the trending attributes user interface 750 comprises the behavior classification, e.g., classifying Myron Jones as a Rate Surfer, and possibly the actual attributes associated with the Rate Surfer (and/or other) behaviors. For example, information regarding specific attributes (e.g., largest balance transferred, average time between transfers, etc.) associated with behaviors of the consumer may be provided to the client, such as in the user interface 760 and/or in response to the client selecting a link 762 that initiates opening of another user interface. In other embodiments, additional and/or less information regarding the consumer may be retrieved by the credit attribute delivery system 730, such as in response to client-specific preferences. Because the exchange of information between the devices happens substantially immediately and the trending attributes do not need to be calculated since they are already stored on the precalculated trending attribute database 128, the retrieval of the trending attributes occurs in real time, and the client trending attributes user interface 760 is displayed within moments, e.g., seconds, of the time that the Get Trending Data button 715 is activated. Thus, trending attributes may be provided to the client in a real-time manner through use of the precalculated trading attributes database 128.

In other embodiments, the consumer information 720 may be transmitted directly to the precalculated trending attributes database 128. In this embodiment, the precalculated trending attributes database 128 may include a processor (and/or other components of a computing device) configured to initiated accessed to the precalculated trending attributes associated with the consumer information 720. In this embodiment, the time required between transmission of the consumer information to return of the precalculated trending attributes may be even further reduced.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A computerized method of providing indications of consumer behaviors with respect to credit accounts associated with the consumers to requesting business entities, the method configured for execution on a computing system comprising one or more computing devices, the method comprising:
determining by the computing system one or more attributes associated with each of a plurality of respective consumers based on credit data associated with respective consumers and one or more trending models that are applied to credit data associated with respective consumers, wherein each attribute is indicative of one or more credit-related transaction of the respective consumers;
storing on a physical storage device indications of the determined attributes for each of the respective consumers;
receiving from a business entity computing device a request for respective behavior indications associated with only a subset of the plurality of consumers, wherein the request includes at least a name and address for each of one or more consumers for which behavior indications are requested;
determining by the computing system at least one behavior indication for each of the subset of consumers based on at least some of the determined attributes associated with the respective consumers, wherein the behavior indication indicates whether respective consumers are more likely to use credit as one or more of a rate surfer, a revolver, or a transactor; and
transmitting to the requesting business entity computing device at least some of the attributes and the determined behavior indications for respective of the subset of consumers, wherein the process of receiving, determining, and transmitting is performed substantially real-time.

2. The method of claim 1, wherein the subset of the plurality of consumer consists of one consumer.

3. The method of claim 1, wherein the subset of the plurality of consumer comprises a plurality of customers of the business entity and/or potential customers of the business entity.

4. The method of claim 1, further comprising:
generating a user interface comprising one or more of the determined attributes for the subset of consumers.

5. The method of claim 1, further comprising:
generating one or more of a comma separated values, extendible markup language, spreadsheet, or database file comprising indications of the determined attributes for the subset of consumers.

6. A computing system configured to determine credit trending attributes for transmission to a client device, wherein the credit trending attributes are each indicative of at least one credit-related transaction of respective consumers and the credit trending attributes are predictive of future credit behavior of each of the plurality of respective consumers, the computing system comprising:
a processor configured to execute one or more modules;
an interface to a network of computing devices;
a trending module configured for execution by the processor in order to generate one or more trending attributes for each of a plurality of consumers by applying one or more respective trending models to credit data corresponding to respective consumers;
a precalculated trending attribute data structure configured to store the one or more trending attributes associated with respective consumers, the precalculated trending attribute data structure comprising an interface module configured to intermittently receive requests for trending attributes from various business entities and, in response to those requests
identify one or more stored trending attributes in the precalculated trending attribute data structure associated with each respective consumer identified by a requesting business entity; and
transmit indications of the stored trending attributes to the requesting business entity, wherein the identifying and transmitting is performed substantially realtime.

7. The computing system of claim 6, wherein the computing system is further configured to determining at least one behavior indication for each of the consumers identified by a requesting business entity based on at least some of the trending attributes associated with the respective consumers, wherein the behavior indication indicates whether respective consumers are more likely to use credit as one or more of a rate surfer, a revolver, or a transactor

8. The computing system of claim 6, wherein certain of the trending models determine attributes based on data regarding debit accounts.

9. A computerized method of providing indications of consumer behaviors with respect to financial accounts associated with the consumers, the method configured for execution on a computing system comprising one or more computing devices, the method comprising:
determining one or more attributes associated with each of a plurality of respective consumers based on trending models that are applied to financial data associated with respective consumers;
storing on a physical storage device indications of the determined attributes for each of the respective consumers;
receiving a request for attributes associated with only a subset of the plurality of consumers, wherein the request includes at least a name and address for each of one or more consumers for which behavior indications are requested; and
transmitting at least some of the attributes associated with respective of the subset of consumers, wherein the process of receiving and transmitting is performed substantially real-time.

10. The computerized method of claim 9, wherein financial data comprises one or more of credit data, credit-related data, debit data, debit-related data, loan data, demographic data, and/or publicly available data.

11. The computerized method of claim 9, further comprising:
determining at least one behavior indication for each of the subset of consumers based on at least some of the determined attributes associated with the respective consumers.

12. The computerized method of claim 11, wherein each behavior indication indicates whether respective consumers are more likely to use credit as one or more of a rate surfer, a revolver, or a transactor.

13. The computerized method of claim 9, wherein the request includes an indication of particular attributes to be returned to a requesting entity.

14. The computerized method of claim 9, wherein the request includes an indication that attributes associated with one or more indicated behaviors are to be returned to a requesting entity.

15. The computerized method of claim 9, further comprising:
generating a user interface configured for transmission to a requesting entity and for receiving at least the name and address of the subset of consumers.

16. The computerized method of claim 9, further comprising:
generating a user interface configured for transmission to a requesting entity, the user interface comprising one or more of the determined attributes for the subset of consumers.

17. The computerized method of claim 9, wherein the transmitted attributes are included in a file that is configured for analysis by one or more software applications of a requesting entity.

18. The computerized method of claim 9, wherein the attributes are configured to allow evaluation of trends in the consumers' respective credit behavior over a period of time.

19. The computerized method of claim 9, wherein the transmitted attributes are transmitted to a requesting entity, wherein the requesting entity is selected from the group comprising: a lender, a bank, a credit bureau, a marketer, a retailer, a wholesaler, a business, and/or an individual.

20. A computer readable medium storing software code configured for execution by a computing device having one or more processors, wherein the software code is configured to cause the computing device to identify and transmit precalculated trending attributes indicative of past credit-related behaviors of consumers to a requesting business entity in a substantially real-time manner, the method comprising:
receiving a request for trending attributes associated with a plurality of consumers, wherein the request includes at least a name and address for each of one or more consumers for which behavior indications are requested;
identifying precalculated trending attributes associated with respective of the plurality of consumers as stored in at least one precalculated trending attributes data store; and
transmitting at least some of the identified trending attributes to a requesting entity, wherein the process of identifying and transmitting is performed substantially real-time.
